(19) United States
(12) Patent Application Publication
(10) Pub. No.: US 2021/0362459 A1
(43) Pub. Date: Nov. 25, 2021

(54) THREE-DIMENSIONAL MULTI-LAYER LAMINATED SHEET

(71) Applicant: Chaei Hsin Enterprise Co., Ltd., Taichung City (TW)

(72) Inventor: Shui-Mu Wang, Taichung City (TW)

(21) Appl. No.: 16/903,367

(22) Filed: Jun. 16, 2020

(30) Foreign Application Priority Data
May 22, 2020 (TW) 109117050

(51) Int. Cl. B32B 1/00; B32B 27/08; B32B 3/10

(52) U.S. Cl. CPC B32B 1/00; B32B 27/08; B32B 2451/00; B32B 2250/02; B32B 2250/03; B32B 3/10

(57) ABSTRACT

A three-dimensional (3D) multi-layer laminated sheet includes a first film and a second film. The first film has at least one 3D structure formed thereon. The second film has at least one opening portion formed thereon. The at least one opening portion corresponds to the at least one 3D structure and is attached to a surface of the at least one 3D structure, so as to form the 3D multi-layer laminated sheet.

### BACKGROUND OF THE INVENTION

### 1. Field of the Invention

The present disclosure relates to a three-dimensional (3D) multi-layer laminated sheet, and more particularly, to a 3D multi-layer laminated sheet which is applicable to a surface of an object and has at least 3D structure.

### 2. Description of the Prior Art

In general, an artificial leather is formed with a predetermined pattern by embossing, printing or laminating surface film. However, the pattern formed on the artificial leather by the aforementioned methods is hardly featured with 3D effect. Specifically, a height of the pattern formed on the artificial leather by the aforementioned methods is limited by a thickness of the artificial leather, which causes the visual limitation and application limitation.

### SUMMARY OF THE INVENTION

The present disclosure aims at providing a three-dimensional (3D) multi-layer laminated sheet which is applicable to a surface of an object and has a 3D structure for solving the above drawbacks.

According to an embodiment of the present disclosure, a 3D multi-layer laminated sheet includes a first film and a second film. The first film has at least one 3D structure formed thereon. The second film has at least one opening portion formed thereon. The at least one opening portion corresponds to the at least one 3D structure and is attached to a surface of the at least one 3D structure, so as to form the 3D multi-layer laminated sheet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a three-dimensional (3D) multi-layer laminated sheet according to a first embodiment of the present disclosure.

FIG. 2 is an exploded diagram showing the 3D multi-layer laminated sheet according to the first embodiment of the present disclosure.

FIG. 3 is a partial schematic diagram showing the 3D multi-layer laminated sheet according to the first embodiment of the present disclosure.

FIG. 4 is a cross-sectional view of the 3D multi-layer laminated sheet taken along line A-A in FIG. 3.

FIG. 5 is a partial schematic diagram showing a 3D multi-layer laminated sheet according to a second embodiment of the present disclosure.

FIG. 6 is a cross-sectional view of the 3D multi-layer laminated sheet taken along line B-B in FIG. 5.

FIG. 7 is a partial schematic diagram showing a 3D multi-layer laminated sheet according to a third embodiment of the present disclosure.

FIG. 8 is a cross-sectional view of the 3D multi-layer laminated sheet taken along line C-C in FIG. 7.

FIG. 9 is a partial schematic diagram showing a 3D multi-layer laminated sheet according to a fourth embodiment of the present disclosure.

FIG. 10 is a cross-sectional view of the 3D multi-layer laminated sheet taken along line D-D in FIG. 9.

FIG. 11 is a partial schematic diagram showing a 3D multi-layer laminated sheet according to a fifth embodiment of the present disclosure.

FIG. 12 is a cross-sectional view of the 3D multi-layer laminated sheet taken along line E-E in FIG. 11.

FIG. 13 is a cross-sectional view of a 3D multi-layer laminated sheet according to a sixth embodiment of the present disclosure.

### DETAILED DESCRIPTION

In the following detailed description of the embodiments, reference is made to the accompanying drawings which form a part thereof, and in which is shown by way of illustration specific embodiments in which the disclosure may be practiced. In this regard, directional terminology, such as top, bottom, left, right, front or back, is used with reference to the orientation of the Figure (s) being described. The components of the present disclosure can be positioned in a number of different orientations. As such, the directional terminology is used for purposes of illustration and is in no way limiting. In addition, identical components or similar numeral references are used for identical components or similar components in the following embodiments. Accordingly, the drawings and descriptions will be regarded as illustrative in nature and not as restrictive. Further, the term “3D” structure refers a structure upwardly protrudes from an upper surface of a main body or downwardly protrudes from a lower surface of the main body. Moreover, the “3D” structure includes, but is not limited to, a height by which the structure upwardly protrudes from the main body being greater than a thickness of the main body or a height by which the structure downwardly protrudes from the main body being greater than the thickness of the main body.

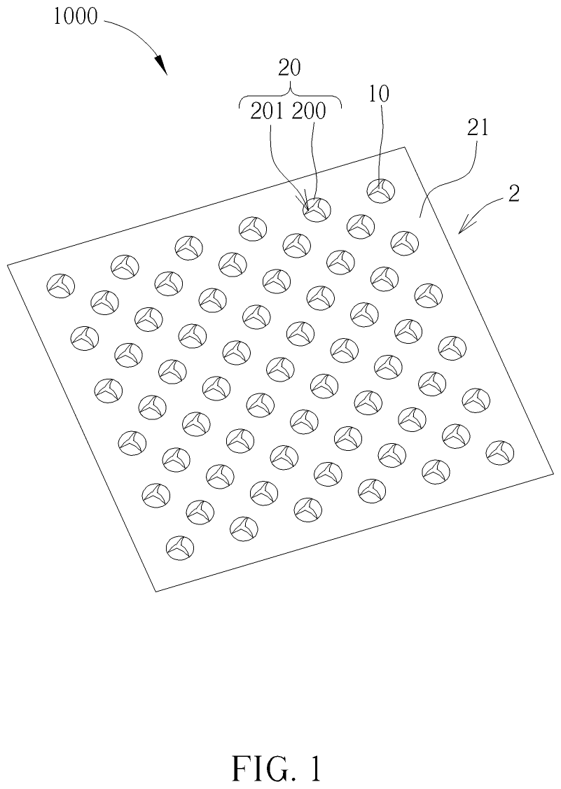

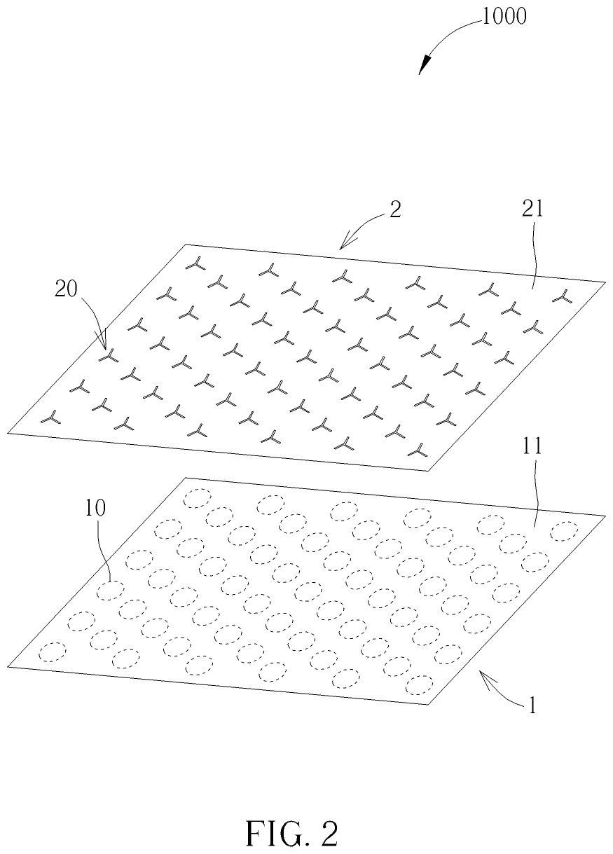

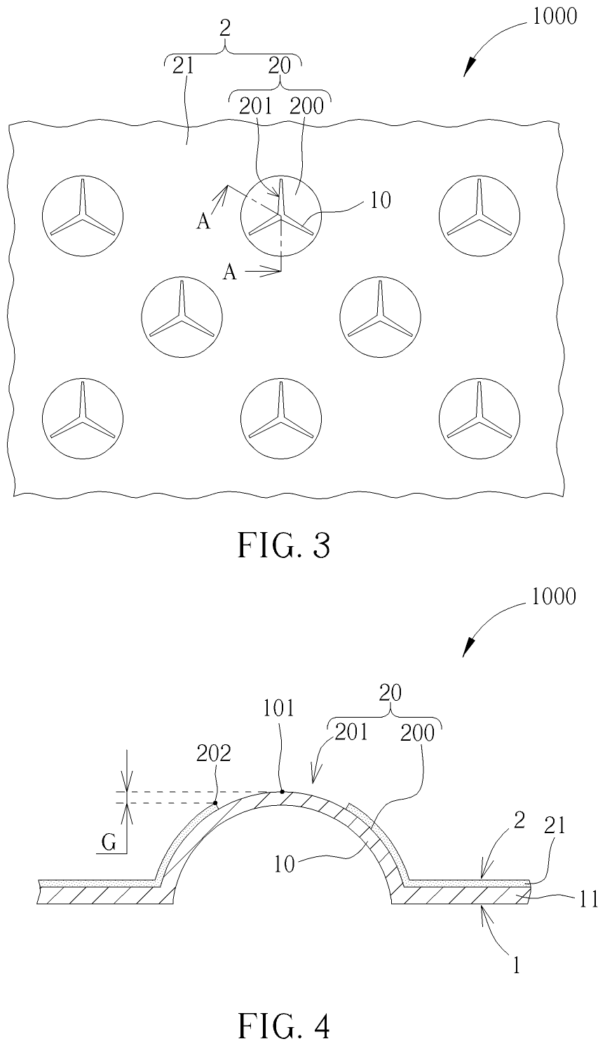

Please refer to FIG. 1 to FIG. 4. FIG. 1 is a schematic diagram showing a 3D multi-layer laminated sheet 1000 according to a first embodiment of the present disclosure. FIG. 2 is an exploded diagram showing the 3D multi-layer laminated sheet 1000 according to the first embodiment of the present disclosure. FIG. 3 is a partial schematic diagram showing the 3D multi-layer laminated sheet 1000 according to the first embodiment of the present disclosure. FIG. 4 is a cross-sectional view of the 3D multi-layer laminated sheet 1000 taken along line A-A in FIG. 3. The 3D multi-layer laminated sheet 1000 includes a first film 1 and a second film 2. The second film 2 is disposed on the first film 1.

The first film 1 includes a first film main body 11 and a plurality of 3D structures 10 formed on the first film main body 11. The second film 2 includes a second film main body 21 and a plurality of opening portions 20 formed on the second film main body 21. Each of the opening portions 20 includes a plurality of extending portions 200. The extending portions 200 of each of the opening portions 20 extend from the second film main body 21 and define an opening 201. The number of the 3D structures 10 and the opening portions 20 are only exemplary and the present disclosure is not limited thereto. For example, the first film 1 can have one 3D structure 10 formed thereon. Also, the second film 2 can have one opening portion 20 formed thereon. That is, the first film 1 has at least one 3D structure 10 formed thereon and the second film 2 has at least one opening portion 20 formed thereon are all within the scope of the present disclosure.

In practical application, the second film 2 can be attached to the first film 1 by a molding method or a vacuum method. During the process of the molding method or the vacuum method, a force is applied to the portions (circled by dashed lines on the first film 1 in FIG. 0.2) of the first film 1 corresponding to the opening portions 20 of the second film 2, such that the portions of the first film 1 protrude toward the second film 2 to form the 3D structures 10. As such, the 3D structures 10 protruding from the first film main body 11 are formed on the first film 1.

During the process of forming the 3D structures 10, the extending portions 200 of the second film 2 are pushed by the 3D structures 10, such that the extending portions 200 are separate from each other to form the opening 201. As such, each of the extending portions 200 of the second film 2 is capable of attaching to a surface of one of the 3D structures, so as to form the 3D multi-layer laminated sheet 1000. In the embodiment, the first film 1 and the second film 2 can be made of a thermoplastic material, such as PE, PP, PS, PMMA, PVC, nylon, PC, PTFE, PET, POM, PU or TPU. The 3D multi-layer laminated sheet 1000 is applicable to a surface of an object (such as an artificial leather, a sports shoe and a bag). With the 3D structures 10 of the 3D multi-layer laminated sheet 1000, the visual effect and application of the object can be enhanced.

In the embodiment, the 3D structure 10 of the first film 1 protrudes from the opening portion 20 of the second film 2. As shown in FIG. 4, a vertex 101 of the 3D structure 10 of the first film 1 protrudes from an upper edge 202 of the extending portion 200 of the second film 2. That is, there is a distance G between the vertex 101 of the 3D structure 10 and the upper edge 202 of the extending portion 200. Furthermore, a distance between the vertex 101 of the 3D structure 10 and an upper surface of the first film main body 11 of the first film 1 is greater than a thickness of the second film 2 and/or the first film 1, such that the portion of the 3D structure 10 adjacent to the vertex 101 can be exposed through the opening 201 of the opening portion 20.

Moreover, in the embodiment, the opening portion 20 is attached to a surface of the 3D structure 10 in a fully laminated manner. That is, the extending portion 200 of the opening portion 20 of the second film 2 is fully attached to the surface of the 3D structure 10 of the first film 1. However, the attaching manner between the opening portion 20 of the second film 2 and the 3D structure 10 of the first film 1 is not limited thereto.

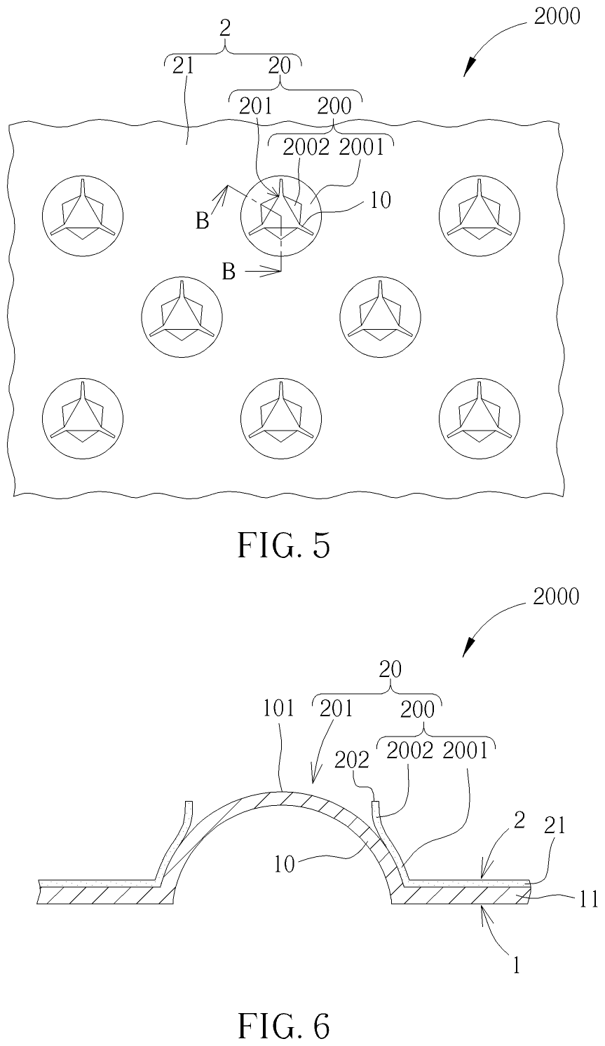

Please refer to FIG. 5 and FIG. 6. FIG. 5 is a partial schematic diagram showing a 3D multi-layer laminated sheet 2000 according to a second embodiment of the present disclosure. FIG. 6 is a cross-sectional view of the 3D multi-layer laminated sheet 2000 taken along line B-B in FIG. 5. The major difference between the 3D multi-layer laminated sheet 2000 and the 3D multi-layer laminated sheet 1000 is illustrated as follows. In the 3D multi-layer laminated sheet 2000, the extending portion 200 of the second film 2 includes an attached portion 2001 and an unattached portion 2002. The attached portion 2001 is attached to one 3D structure 10 of the first film 1, and the unattached portion 2002 is not attached to the 3D structure 10 of the first film 1. In other words, in the 3D multi-layer laminated sheet 2000, the opening portion 20 is attached to the surface of the 3D structure 10 of the first film 1 in a partially laminated manner. As such, the unattached portion 2002 of the opening portion 20 of the second film 2 is separated from the 3D structure 10 of the first film 1, such that the 3D structure 10 of the first film 1 and the extending portion 200 of the second film 2 together forma flower-like structure (as shown in FIG. 5).

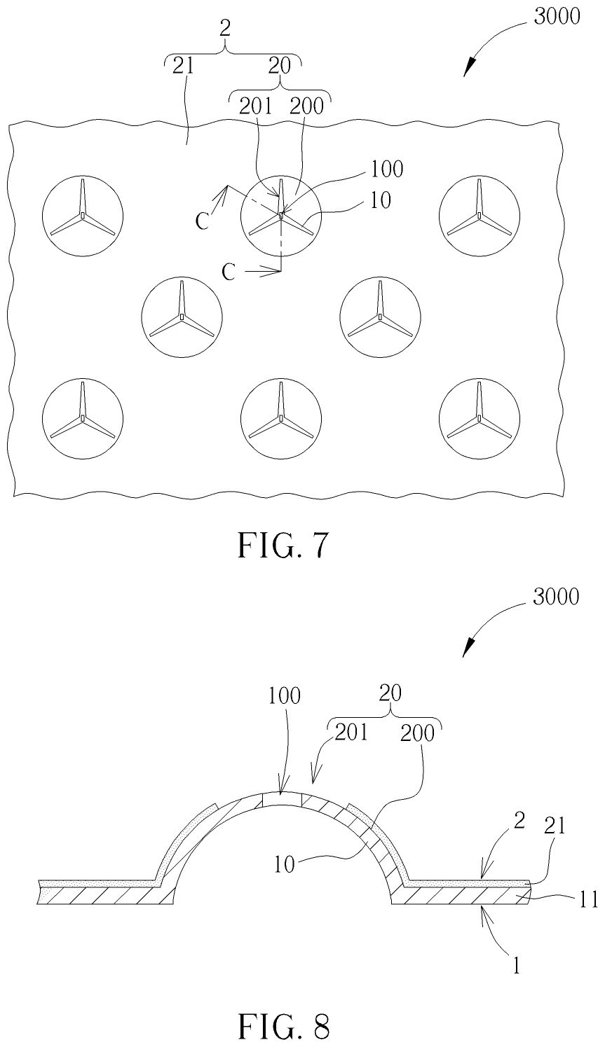

Please refer to FIG. 7 and FIG. 8. FIG. 7 is a partial schematic diagram showing a 3D multi-layer laminated sheet 3000 according to a third embodiment of the present disclosure. FIG. 8 is a cross-sectional view of the 3D multi-layer laminated sheet 3000 taken along line C-C in FIG. 7. The major difference between the 3D multi-layer laminated sheet 3000 and the 3D multi-layer laminated sheet 1000 is that the 3D structure 10 of the first film 1 of the 3D multi-layer laminated sheet 3000 has a breach portion 100 on a top end of the 3D structure 10. In the embodiment, the breach portion 100 is a through hole, and the breach portion 100 can be a linearity-shaped through hole, a polygon-shaped through hole, a star-shaped through hole, or an astral-shaped through hole, which depends on practical demands. In the embodiment, a shape of the opening 201 is astral-shaped, as shown in FIG. 7, a shape (linear shape) of the breach portion 100 (i.e., the through hole) can be partially corresponding to the shape (astral shape) of the opening 201. However, the present disclosure is not limited thereto. The shape of the breach portion 100 can be completely corresponding to the shape of the opening 201. Moreover, in another embodiment, the shape of the opening 201 of the second film 2 can be other shapes, such as a linear shape, a polygonal shape or a star shape. Alternatively, the second film 2 can include a plurality of the openings 201, and the shapes of the plurality of the openings 201 can be a combination of at least two of the aforementioned shapes. For example, the combination of at least two of the aforementioned shapes can include the linear shape and the star shape, and a portion of the plurality of the openings 201 are formed in linear shape, and the other portion of the plurality of the openings 201 are formed in star shape.

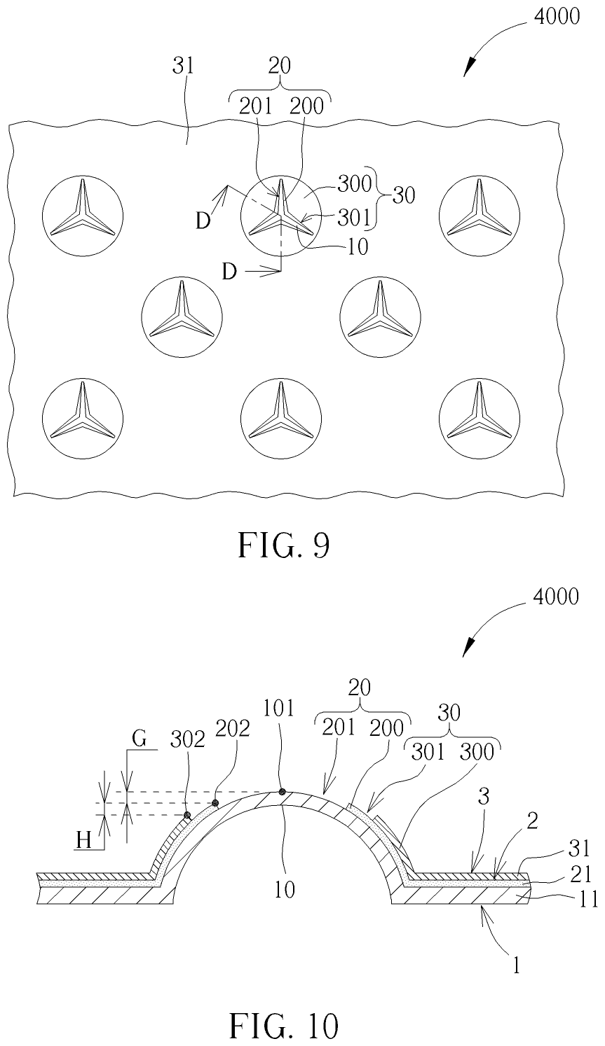

Please refer to FIG. 9 and FIG. 10. FIG. 9 is a partial schematic diagram showing a 3D multi-layer laminated sheet 4000 according to a fourth embodiment of the present disclosure. FIG. 10 is a cross-sectional view of the 3D multi-layer laminated sheet 4000 taken along line D-D in FIG. 9. The major difference between the 3D multi-layer laminated sheet 4000 and the 3D multi-layer laminated sheet 1000 is provided as follows. The 3D multi-layer laminated sheet 4000 further includes a third film 3. The third film 3 is disposed on the second film 2. The third film 3 includes a third film main body 31 and a plurality of notch portions 30. Each of the notch portions 30 includes a plurality of extending structures 300. The extending structures 300 of each of the notch portions 30 extend from the third film main body 31 and define a notch 301. The number of the notch portions 30 is only exemplary and the present disclosure is not limited thereto. For example, the third film 3 can have one notch portion 30 formed thereon. That is, the third films 3 have at least one notch portion 30 formed thereon are all within the scope of the present disclosure.

In practical application, the third film 3 can be attached to the second film 2 by the molding method or the vacuum method. During the process of the molding method or the vacuum method, the portions of the first film 1 corresponding to the opening portions 20 of the second film 2 protrude toward the second film 2 and the third film 3 to form 3D structures 10. As such, the first film 1 can be formed with a structure including the first film main body 11 and the 3D structures 10 protruding from the first film main body 11.

During the process of forming the 3D structures 10, the extending portions 200 of the second film 2 and the extending structures 300 of the third film 3 are pushed by the 3D structures 10, such that the extending portions 200 are separated from each other to form the opening 201, and the extending structures 300 are separated from each other to form the notch 301. As such, the extending portions 200 of the second film 2 are capable of attaching to the surface of the 3D structures 10 of the first film 1, and the extending structures 300 of the third film 3 are capable of correspondingly attached to the extending portions 200 of the second film 2, so as to form the 3D multi-layer laminated sheet 4000.

In the embodiment, the 3D structure 10 of the first film 1 protrudes from the opening portion 20 of the second film 2 and the notch portion 30 of the third film 3. As shown in FIG. 10, the vertex 101 of the 3D structure 10 of the first film 1 is located above the upper edge 202 of the extending portion 200 of the second film 2, and the upper edge 202 of the extending portion 200 of the second film 2 is located above an upper edge 302 of the extending structure 300 of the third film 3. That is, there is a distance G between the vertex 101 of the 3D structure 10 and the upper edge 202 of the extending portion 200, and there is a height difference H between the upper edge 202 of the extending portion 200 and the upper edge 302 of the extending structure 300. Furthermore, a distance between the vertex 101 of the 3D structure 10 and the upper surface of the first film main body 11 of the first film 1 is greater than a sum of a thickness of the second film 2 and a thickness of the third film 3, such that a portion of the 3D structure 10 adjacent to the vertex 101 of the first film 1 can be exposed through the opening 201 of the second film 2, and a portion of the opening portion 20 adjacent to the upper edge 202 of the extending portion 200 of the second film 2 can be exposed through the notch 301 of the notch portion 30 of the third film 3.

In other words, since the portion of the opening portion 20 adjacent to the upper edge 202 of the extending portion 200 of the second film 2 can be exposed through the notch 301 of the third film 3, a size of the notch 301 of the third film 3 is greater than a size of the opening 201 of the second film 2.

Moreover, in the embodiment, the opening portion 20 of the second film 2 is attached to the surface of the 3D structure 10 of the first film 1 in a fully laminated manner, and the notch portion 30 of the third film 3 is attached to the opening portion 20 of the second film 2 in a fully laminated manner. That is, the extending portion 200 of the opening portion 20 of the second film 2 is fully attached to the surface of the 3D structure 10 of the first film 1, and the extending structure 300 of the third film 3 is fully attached to the extending portion 200 of the second film 2. However, the attaching manner between the opening portion 20 of the second film 2 and the 3D structure 10 of the first film 1, and the attaching manner between the notch portion 30 of the third film 3 and the opening portion 20 of the second film 2 are not limited thereto.

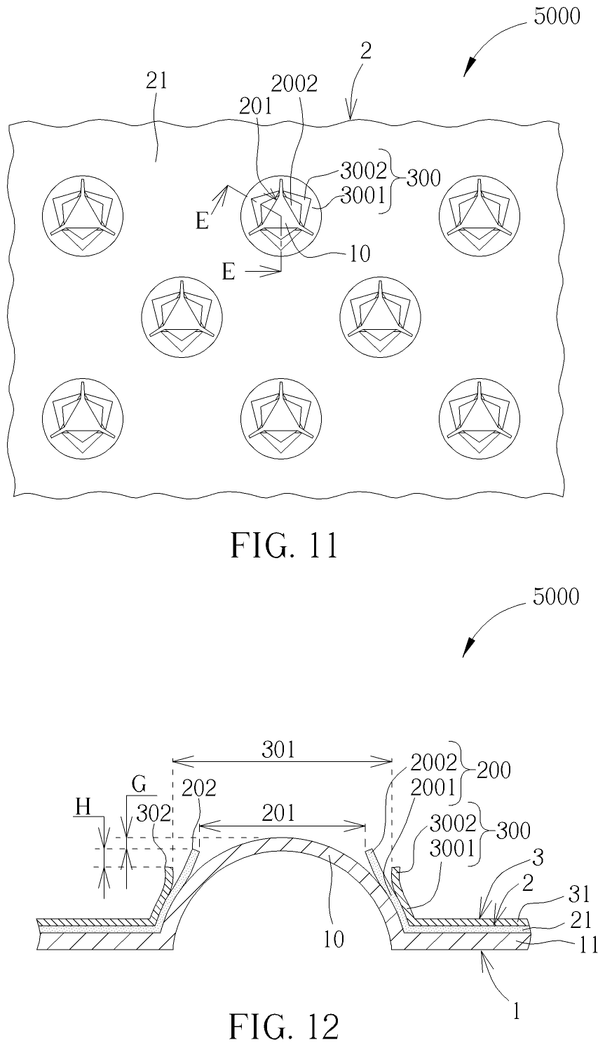

Please refer to FIG. 11 and FIG. 12. FIG. 11 is a partial schematic diagram showing a 3D multi-layer laminated sheet 5000 according to a fifth embodiment of the present disclosure. FIG. 12 is a cross-sectional view of the 3D multi-layer laminated sheet 5000 taken along line E-E in FIG. 11. The major difference between the 3D multi-layer laminated sheet 5000 and the 3D multi-layer laminated sheet 4000 is provided as follows. The extending portion 200 of the second film 2 of the 3D multi-layer laminated sheet 5000 includes the attached portion 2001 and the unattached portion 2002. The attached portion 2001 is attached to the 3D structure 10 of the first film 1, and the unattached portion 2002 is not attached to the 3D structure 10 of the first film 1 and is separated from the 3D structure 10 of the first film 1. The extending structure 300 of the notch portion 30 of the third film 3 of the 3D multi-layer laminated sheet 5000 includes an attached portion 3001 and an unattached portion 3002. The attached portion 3001 is attached to the extending portion 200 of the second film 2, and the unattached portion 3002 is not attached to the extending portion 200 of the second film 2 and is separated from the opening portion 20 of the second film 2.

In other words, in the 3D multi-layer laminated sheet 5000, the extending portion 200 of the second film 2 is attached to the 3D structure 10 of the first film 1 in a partially laminated manner, and the extending structure 300 of the third film 3 is attached to the extending portion 200 of the second film 2 in a partially laminated manner. As such, the unattached portion 2002 of the opening portion 20 of the second film 2 is separated from the 3D structure 10 of the first film 1, and the unattached portion 3002 of the notch portion 30 of the third film 3 is separated from the extending portion 200 of the second film 2, such that the 3D structure 10 of the first film 1, the extending portion 200 of the opening portion 20 of the second film 2 and the extending structure 300 of the notch portion 30 of the third film 3 together form a double-layer flower-like structure (as shown in FIG. 11).

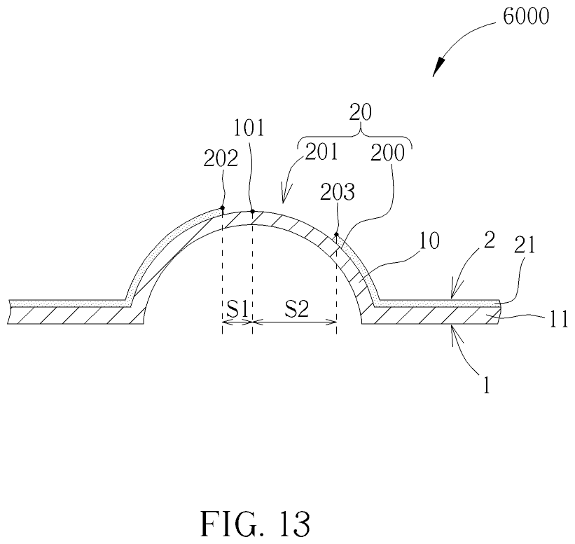

Please refer to FIG. 13. FIG. 13 is a cross-sectional view of a 3D multi-layer laminated sheet 6000 according to a sixth embodiment of the present disclosure. The major difference between the 3D multi-layer laminated sheet 6000 and the aforementioned 3D multi-layer laminated sheets is provided as follows. In the 3D multi-layer laminated sheet 6000, a central position of the opening 201 of the second film 2 and a central position of the 3D structure 10 of the first film 1 are not arranged on a straight line. That is, a distance S1 between the vertex 101 of the 3D structure 10 and the upper edge 202 of the extending portion 200 of the opening portion 20 does not equal to a distance S2 between the vertex 101 of the 3D structure 10 and an upper edge 203 of the extending portion 200 of the opening portion 20. In other words, in the 3D multi-layer laminated sheet 6000, the opening portion 20 of the second film 2 is attached to the 3D structure 10 of the first film 1 in a stagger manner. Furthermore, in the 3D multi-layer laminated sheet 4000 of the fourth embodiment according to the present disclosure, the extending portion 200 of the second film 2, the extending structure 300 of the third film 3 and the 3D structure 10 of the first film 1 can also be attached in a stagger manner.

Comparing to prior art, the first film of the present disclosure has at least one 3D structure formed thereon, and the second film of the present disclosure has at least one opening portion corresponding to the 3D structure of the first film. The 3D multi-layer laminated sheet of the present disclosure can be obtained by attaching the opening portion of the second film to the surface of the 3D structure of the first film. Therefore, the 3D multi-layer laminated sheet of the present disclosure can have 3D pattern (i.e., the 3D structure) and is applicable to a surface on an object (such as an artificial leather, a sports shoe and a bag), such that the visual effect and application can be enhanced.

Those skilled in the art will readily observe that numerous modifications and alterations of the device and method may be made while retaining the teachings of the invention. Accordingly, the above disclosure should be construed as limited only by the metes and bounds of the appended claims.

1. A three-dimensional (3D) multi-layer laminated sheet, comprising:
a first film having at least one 3D structure formed thereon; and
a second film having at least one opening portion formed thereon, wherein the at least one opening portion corresponds to the at least one 3D structure and is attached to a surface of the at least one 3D structure, so as to form the 3D multi-layer laminated sheet;
wherein the opening portion comprises a plurality of extending portions and an opening, during a process of forming the 3D structure, the plurality of extending portions are pushed by the 3D structure, such that the plurality of extending portions are separate from each other to form the opening.

2. The 3D multi-layer laminated sheet of claim 1, wherein the at least one opening portion is attached to the surface of the at least one 3D structure in a fully laminated manner.

3. The 3D multi-layer laminated sheet of claim 1, wherein the at least one opening portion is attached to the surface of the at least one 3D structure in a partially laminated manner.

4. The 3D multi-layer laminated sheet of claim 1, wherein the at least one 3D structure has at least one breach portion, and the at least one opening portion is fully corresponding to the breach portion or partially corresponding to the breach portion.

5. (canceled)

6. The 3D multi-layer laminated sheet of claim 1, wherein a shape of the opening comprises a linear shape, a polygonal shape or a star shape.

7. The 3D multi-layer laminated sheet of claim 1, wherein the at least one 3D structure protrudes from the at least one opening portion.

8. The 3D multi-layer laminated sheet of claim 1, further comprising:
a third film having at least one notch portion formed thereon, wherein the at least one notch portion corresponds to the at least one opening portion and is attached to a surface of the at least one opening portion.

9. The 3D multi-layer laminated sheet of claim 8, wherein the at least one notch portion is attached to the surface of the at least one opening portion in a fully laminated manner.

10. The 3D multi-layer laminated sheet of claim 8, wherein the at least one notch portion is attached to the surface of the at least one opening portion in a partially laminated manner.
